(19) United States
(12) Patent Application Publication
(10) Pub. No.: US 2026/0312819 A1
(43) Pub. Date: Oct. 8, 2026

(54) APPROXIMATED CARDINALITY SYSTEM

(71) Applicant: SAP SE, Walldorf (DE)

(72) Inventors: Emmanuel Zarpas, Paris (FR); Pierre-Olivier Ceffis, Asnières Sur Seine (FR)

(21) Appl. No.: 19/172,947

(22) Filed: Apr. 8, 2025

(51) Int. Cl. H04L 9/32

(52) U.S. Cl. CPC H04L 9/3236

(57) ABSTRACT

A system inserts a first element of a plurality of elements of a given dataset into a bit array by setting at least one bit to one in the bit array, and then, for each element of the plurality of elements, after the first element, that is inserted in the bit array, the system, for each hash function, applies a hash function to the element to produce an index in the bit array, sets a bit to one at the index in the bit array, counts a number of collisions that occur, and updates a number of bits set to one in the bit array based on the number of collisions. The system analyzes a set of results based on these operations and selects an optimized bit array size and an optimal number of hash functions.

### BACKGROUND

In business intelligence and analytics workflows, determining the cardinality (number of distinct values) of data dimensions is critical for optimizing visualization and user interface behaviors. For example, the appropriate visualization type in a user interface may depend on the number of distinct categories. For instance, a pie chart becomes ineffective with too many segments, and it may not make sense to offer a search feature when there are only a few distinct values. Similarly, user interface elements like value selection lists need different implementations based on the number of available choices.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some examples.

FIG. 2 is a flow chart illustrating aspects of a method, according to some examples.

FIG. 3 is a flow chart illustrating aspects of a method, according to some examples.

FIGS. 4A-4C and 5A-5C include various charts, according to some examples.

FIG. 6 is a block diagram illustrating an example of a software architecture that may be installed on a machine, according to some examples.

FIG. 7 illustrates a diagrammatic representation of a machine, in the form of a computer system, within which a set of instructions may be executed for causing the machine to perform any one or more of the methodologies discussed herein, according to some examples.

### DETAILED DESCRIPTION

As mentioned above, determining the cardinality, which is the number of distinct values, of data dimensions is critical for optimizing visualization and user interface behaviors. While database statistics can sometimes provide cardinality information for master data, this approach has significant limitations. Database statistics are computationally expensive to maintain and may not always be implemented. More critically, these statistics become irrelevant when filters are applied to the data, which occurs frequently in analytics workflows.

The challenge is further complicated in enterprise scenarios where dimensions can contain millions of distinct values, such as product references in retail applications. Retrieving and counting all distinct values becomes impractical in these cases, as it would consume excessive time and computational resources. However, in many analytics use cases, an exact count is unnecessary. Instead, the system only needs to determine whether the cardinality falls above or below a certain threshold to make appropriate visualization and user interface decisions.

An approximated cardinality system is described herein that addresses at least these technical problems by using a bit array approach (such as a Bloom filter) that provides an efficient way to determine whether a dimension's cardinality is above or below a specified threshold. The solution is both fast and resource-efficient, as it works incrementally by inserting values into the Bloom filter and stopping once a certain number of “1” bits indicates the threshold has been crossed. The approximated cardinality system supports filtering by only inserting non-filtered values, and its parameters can be optimized through Monte Carlo simulation to provide statistical guarantees about accuracy while maintaining minimal computational overhead. This enables real-time cardinality estimation for interactive user interface workflows while using minimal CPU and memory resources.

For example, the approximated cardinality system initializes a bit array of a predetermined size and a predefined number of hash functions. For each dataset, the approximated cardinality system, performs operations, for a number of iterations, to generate a set of results comprising a result for each iteration. First, the approximated cardinality system inserts a first element of a plurality of elements of the given dataset into the bit array by setting at least one bit to one in the bit array, and then, for each element of the plurality of elements, after the first element, that is inserted in the bit array, the approximated cardinality system applies each hash function to the element to produce an index in the bit array, sets setting a bit to one at the index in the bit array, counts a number of collisions that occur, and updates a number of bits set to one in the bit array based on the number of collisions. The approximated cardinality system analyzes the set of results to determine a number of bits set to one in the bit array after inserting the plurality of elements, for each result and selects an optimized bit array size and an optimal number of hash functions based on a mean and standard deviation of the number of bits set to one in the bit array for a given number of hash functions given a specified user interface threshold value for a given user interface function. The approximated cardinality system and functions are described in further detail below.

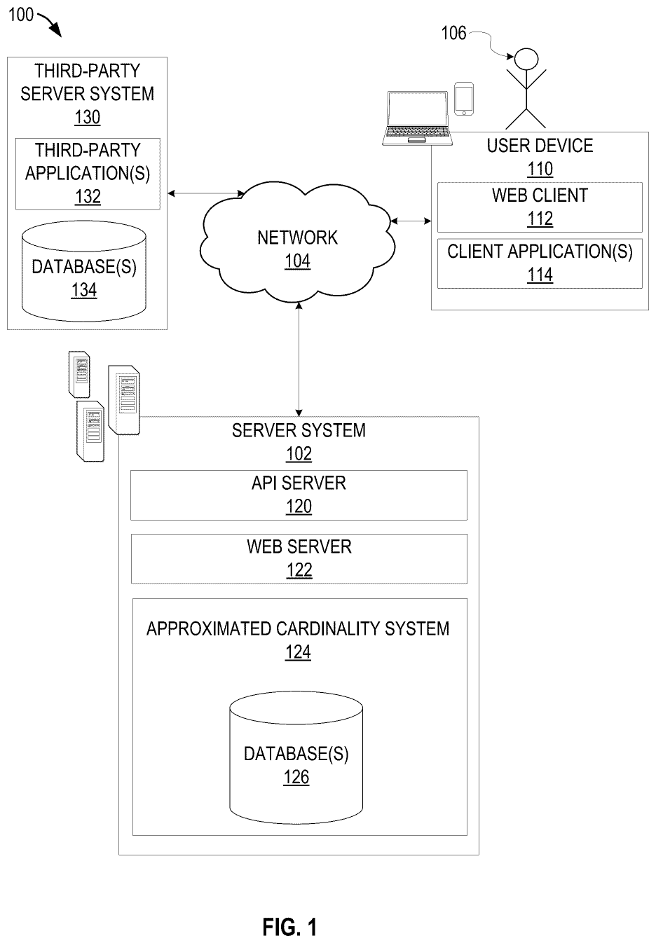

FIG. 1 is a block diagram illustrating a networked system 100, according to some example embodiments. The system 100 can include one or more user devices such as user device 110. The user device 110 can comprise, but is not limited to, a mobile phone, desktop computer, laptop, portable digital assistant (PDA), smart phone, tablet, ultrabook, netbook, laptop, multi-processor system, microprocessor-based or programmable consumer electronic, game console, set-top box, computer in a vehicle, wearable computing device, or any other computing or communication device that a user may utilize to access the networked system 100. In some embodiments, the user device 110 comprises a display module (not shown) to display information (e.g., in the form of user interfaces). In further embodiments, the user device 110 can comprise one or more of touch screens, accelerometers, gyroscopes, cameras, microphones, global positioning system (GPS) devices, and so forth. The user device 110 can be a device of a user 106 that is used to access and utilize an approximated cardinality system 124 for queries or related features, among other applications.

One or more users 106 may be a person, a machine, or other means of interacting with the user device 110. In example embodiments, the user 106 may not be part of the system 100 but may interact with the system 100 via the user device 110 or other means. For instance, the user 106 can provide input (e.g., touch screen input or alphanumeric input) to the user device 110 and the input can be communicated to other entities in the system 100 (e.g., third-party server system 130, server system 102) via a network 104. In this instance, the other entities in the system 100, in response to receiving the input from the user 106, communicate information to the user device 110 via the network 104 to be presented to the user 106. In this way, the user 106 can interact with the various entities in the system 100 using the user device 110.

The system 100 further includes a network 104. One or more portions of network 104 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The user device 110 can access the various data and applications provided by other entities in the system 100 via web client 112 (e.g., a browser, such as the Internet Explorer® browser developed by Microsoft® Corporation of Redmond, Washington State) or one or more client applications 114. The user device 110 can include one or more client applications 114 (also referred to as “apps”) such as, but not limited to, a web browser, a search engine, a messaging application, an electronic mail (email) application, an e-commerce site application, a mapping or location application, an enterprise resource planning (ERP) application, a customer relationship management (CRM) application, an application for accessing and utilizing the approximated cardinality system 124, and the like.

In some embodiments, one or more client applications 114 are included in a given user device 110, and configured to locally provide the user interface and at least some of the functionalities, with the client application(s) 114 configured to communicate with other entities in the system 100 (e.g., third-party server system 130, server system 102, etc.), on an as-needed basis, for data and/or processing capabilities not locally available (e.g., access location information, access machine learning models, to authenticate a user 106, to verify a method of payment, access the approximated cardinality system 124, and so forth), and so forth. Conversely, one or more client applications 114 may not be included in the user device 110, and then the user device 110 can use its web browser to access the one or more applications hosted on other entities in the system 100 (e.g., third-party server system 130, server system 102).

A server system 102 provides server-side functionality via the network 104 (e.g., the Internet or wide area network (WAN)) to one or more third-party server system 130 and/or one or more user devices 110. The server system 102 can include an application program interface (API) server 120, a web server 122, and approximated cardinality system 124 that can be communicatively coupled with one or more databases 126.

The one or more databases 126 comprise storage devices that store data related to users of the system 100, applications associated with the system 100, cloud services, machine learning models, data related to entities/products/services, and so forth. The one or more databases 126 can further store information related to third-party server system 130, third-party applications 132, third-party database(s) 134, user devices 110, client applications 114, users 106, and so forth. In one example, the one or more databases 126 is cloud-based storage. In some examples, one or more databases 126 stores data related to scenarios, APIs and related information, and other data utilized by the approximated cardinality system 124, as explained in further detail below.

The server system 102 can be a cloud computing environment, according to some example embodiments. The server system 102, and any servers associated with the server system 102, can be associated with a cloud-based application, in one example embodiment.

The approximated cardinality system 124 provides back-end support for third-party applications 132 and client applications 114, which can include cloud-based applications. The approximated cardinality system 124 provides for functions as described in further detail below. The approximated cardinality system 124 can comprise one or more servers or other computing devices or systems.

The system 100 further includes one or more third-party server system 130. The one or more third-party server system 130 can include one or more third-party application(s). The one or more third-party application(s) 132, executing on third-party server(s) 130, can interact with the server system 102 via API server 120 via a programmatic interface provided by the API server 120. For example, one or more of the third-party applications 132 can request and utilize information from the server system 102 via the API server 120 to support one or more features or functions on a website hosted by the third party or an application hosted by the third party.

The third-party website or application 132, for example, can provide access to functionality and data supported by third-party server system 130. In one example embodiment, the third-party website or application 132 provides access to functionality that is supported by relevant functionality and data in the third-party server system 130. In another example, a third-party server system 130 is a system associated with an entity that accesses cloud services via server system 102.

The third-party database(s) 134 can be storage devices that store data related to users of the third-party server system 130, applications associated with the third-party server system 130, cloud services, machine learning models, parameters, and so forth. The one or more databases 126 can further store information related to third-party applications 132, user devices 110, client applications 114, users 106, and so forth. In one example, the one or more databases 134 are cloud-based storage.

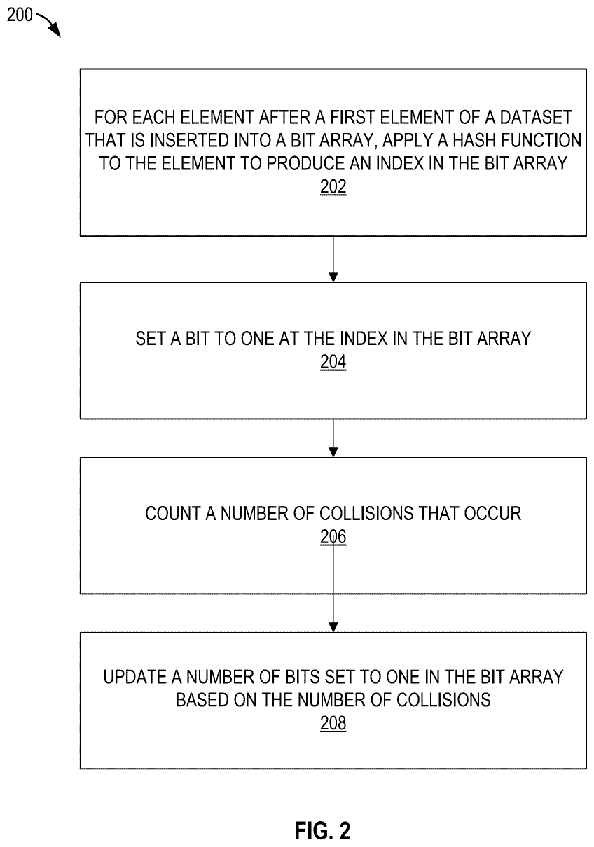

FIG. 2 is a flow chart illustrating aspects of a method 200, for an approximated cardinality system, according to some example embodiments. For illustrative purposes, method 200 is described with respect to the block diagram of FIG. 1. It is to be understood that method 200 can be practiced with other system configurations in other embodiments.

To approximate the cardinality for a given data set, a computing system, such as the server system 102 or approximated cardinality system 124, executes a simulation to estimate a number of bits set to one in a bit array after inserting a plurality of elements of a dataset. In some examples, the simulation is a Monte Carlo simulation, or multiple probability simulation, to estimate possible outcomes of an uncertain event.

In some examples, the bit array is a Bloom filter. The bit array is defined by two parameters. One parameter is the bit array size m, which is the number of bits in the array. The other parameter is the number of hash functions k for the bit array. For a given bit array, X is the number of bits set to 1 in the bit array. To add an element of a dimension (e.g., a value in a dataset) to the bit array, the element is fed to each of the k hash functions and bits are set to 1 in the array positions according to the output of each k hash function. Accordingly, the hash functions are used to map each value to an array position in the bit array.

The goal is to determine whether or not a dimension of distinct values is less than or greater than a given threshold (e.g., 100, 500). Each element of the dimension is added incrementally, and for a given value V of X, the process stops when there is a near certainty that the threshold has been passed. More details on how the optimal values of V, m and k are described in further detail below.

The computing system simulates the behavior of the bit array (e.g., Bloom filter), which is a space-efficient probabilistic data structure used to test whether an element is part of a set. The key is to estimate how many bits in the bit array are set to 1 after inserting a certain number of distinct elements. As mentioned above, this can be done using Monte Carlo simulations.

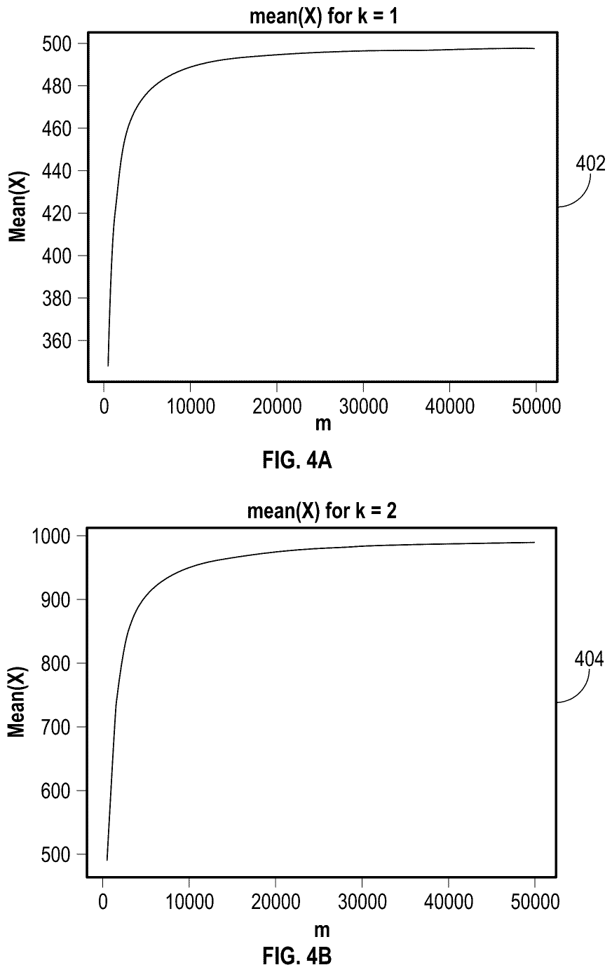

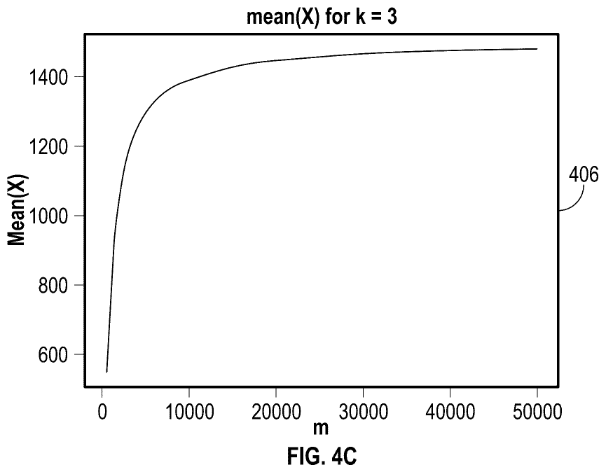

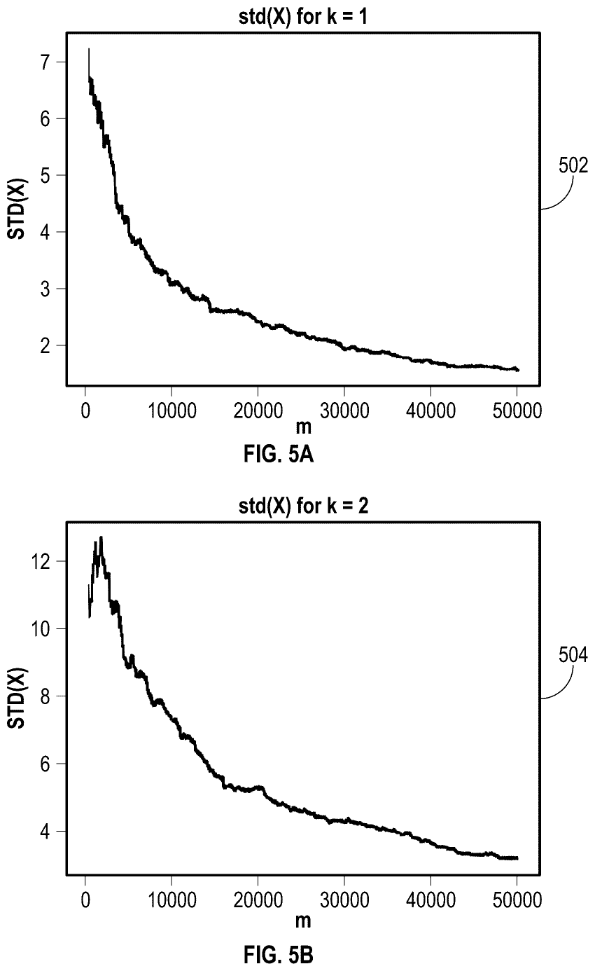

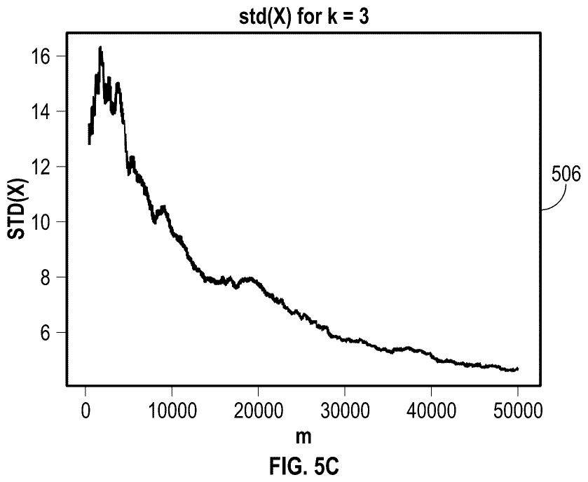

The computing system initializes a bit array of a predetermined size (m) and a predefined number of hash functions (k). For example, the computing device can initialize the bit array to a predetermined size of 10,000 bits, 20,000 bits, or other size, and the number of hash functions to 1, 2, 3, or other number. In some examples, simulations were done with k=1, 2 and 3 and, for each value of k, m from 100 to 50,000 by 100 increments and shown and discussed below with respect to FIGS. 4A-4C and 5A-5C. The computing system can further initialize a random number generator with a specific seed to ensure reproducibility.

The computing system calculates the probability of a collision when inserting elements into the bit array by relying on the properties of hash functions and the bit array to approximate the presence of elements. A collision happens when a hash function maps an element to a bit that is already set to 1. In some examples, the probability of at least one collision when inserting the nth element is given by: collision_probability=1−(1−1/m)^{k·n}.

For a given dataset, the computing system performs the operations of FIG. 2, for a specified number of iterations (e.g., 10,000), to execute the simulation. These operations generate a set of results comprising a result for each iteration.

The computing system inserts a first element of a plurality of elements of the dataset into the bit array by setting at least one bit to one in the bit array. Since it is the first element inserted, the computing system can assume that the first insertion does not cause any collisions. For each subsequent insertion, the computing system simulates the behavior of the k hash function. For example, for each element of the plurality of elements, after the first element, that is inserted in the bit array, the computing device performs the operations in FIG. 2.

In operation 202, the computing system, applies each hash function to the element to produce an index in the bit array and, in operation 204, sets a bit at the index in the bit array. The computing system counts a number of collisions that occur, in operation 206, and updates a number of bits set to one in the bit array based on the number of collisions, in operation 208. If there are fewer than k collisions, a new element is successfully inserted without a false positive (e.g., collision). The count of inserted elements is incremented, and the number of bits set to 1 are updated accordingly.

As mentioned above, this simulation is repeated for a specified number of iterations (e.g., 10,000) to perform Monte Carlo simulations. The results are collected to estimate the expected behavior of the bit array (e.g., Bloom filter) based on the average. For instance, the computing system uses the combination of probability calculations and Monte Carlo simulations to estimate the behavior of the Bloom filter. Simulating the insertion of elements and counting collisions provides an estimate of how many bits in the Bloom filter are set to 1 after a given number of distinct elements. This helps in understanding the efficiency and accuracy of the Bloom filter for different configurations.

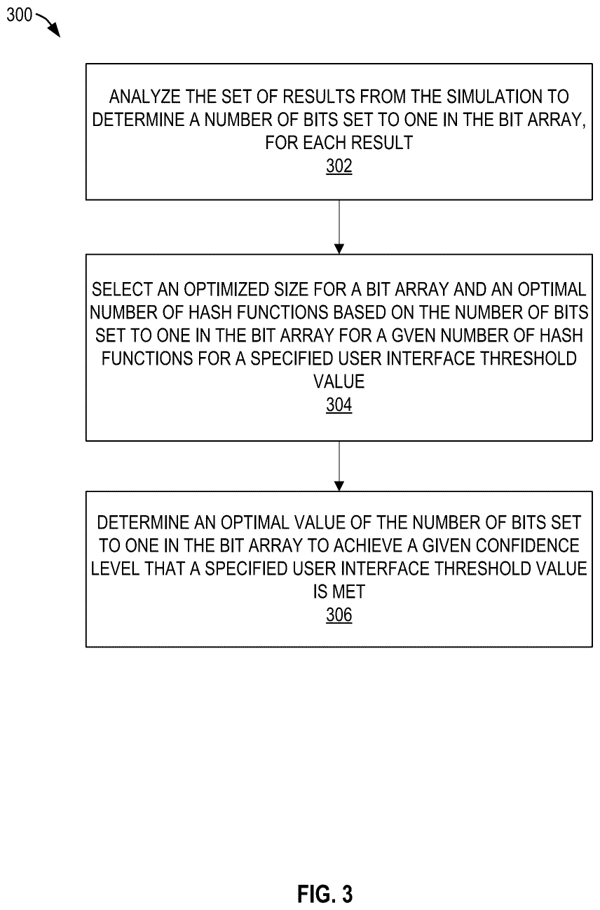

Turning to the flow chart of FIG. 3, the computing system, in operation 302, analyzes the set of results from the simulation to determine a number of bits set to one in the bit array after inserting the plurality of elements (or the specified number of distinct elements), for each result. To determine the optimal bit array parameters, the computing system can then evaluate X (the number of bits set to 1) when the number of distinct elements crosses a given threshold (e.g., 500) and its standard deviation with respect to m (the size of the filter) for a given k with Monte Carlo simulation.

In operation 304, the computing system selects an optimized size for a bit array and an optimal number of hash functions based on the mean and standard deviation of the number of bits set to one in the bit array for a given number of hash functions given a specified user interface threshold value for a given user interface function. FIGS. 4A-4C illustrate the Monte Carlo estimation of X versus m. Each chart in FIGS. 4A-4C illustrates the mean of X for a different k value, wherein X is the number of bits set to 1, k is the number of hash functions, and m is the bit array size. For instance, chart 402 illustrates the mean(X) for k=1, chart 404 illustrates the mean(X) for k=2, and chart 406 illustrates the mean(X) for k=3. FIGS. 5A-5C illustrate the precision of estimation of X versus m. Each chart in FIGS. 5A-5C illustrates the standard deviation of X for a different k value. For instance, chart 502 illustrates the std(X) for k=1, chart 504 illustrates the std(X) for k=2, and chart 506 illustrates the std(X) for k=3. In these examples, the specified user interface threshold is 500.

As can be seen in the examples in FIGS. 4A-4C and 5A-5C, for a 500 threshold, k=1 offers a better precision for a similar filter size. A filter size of 10,000 can be selected as it provides a reasonable size to performance ratio. It is noted that a 10,000 bit array is a light and affordable footprint in terms of computing resources. Accordingly, the parameters for the bit array can be set to m=10,000 and k=1 for the optimized size and the optimal number of hash functions for the bit array.

In some examples, the optimized size for the bit array and the optimal number of hash functions are stored in one or more datastores, such as database(s) 126 or 134.

Returning to FIG. 3, in operation 306, the computing system determines an optimal value of the number of bits set to one in the bit array to achieve a given confidence level that a specified user interface threshold value is met by determining a value where a mean plus three times the standard deviation of the set of results exceeds a user interface threshold value. The computing system sets the optimal value to the determined value. For example, the computing system computes the greatest value of X that guarantees that the number of elements is lower than a given threshold with near certainty. To do so we can again use the Monte Carlo simulation. In the example code below, a threshold of 500 is used as an example:

for X_final in range(450, 500):
tmp=run_to_count_monte_carlo(1000, k=1, m=10000, X_final=X_final)
if tmp.mean( )+3*tmp.std( )>500:
   print(k, “: mean”, tmp.mean( ))
   print(k, “: std”, tmp.std( ))
   break
      This example code aims to find the smallest value of X_final (within the range 450 to 500) for which the means plus three time the standard deviation of the results from the Monte Carlo simulation exceeds 500. This is a way to estimate the point at which the number of bits set to 1 in a Bloom filter reaches a certain threshold with high confidence. As the X distribution can be estimated as gaussian, this will guarantee that X is less than the 500 threshold with a 99.7% certainty. The empirical value for X is 490 in this case. In a similar manner, we can establish that is X is greater than 512, the number of distinct values is greater than the 500 threshold with 99.7% certainty.

With the described approach, the computing system can incrementally check whether the number of distinct values of a dimension is lesser or greater than a given threshold (e.g., 500) with near certainty. As soon as the optimal value of the number of bits set to one in the bit array (e.g., 490) is reached, the procedure stops, saving computation time. In addition, filtering is supported in a natural and efficient way since an element is inserted in the Bloom filter only if it is not filtered out. In this way, a bit array, such as a Bloom filter, can be used to decide whether the number of values is lower than a given threshold for a user interface function by inserting each value into the bloom array. When X, the number of 1s in the bit array reach a second threshold (e.g., the optimal value of the number of bits set to one in the bit array), we can conclude that the number of distinct values is greater than the threshold for the user interface function and stop.

An application, such as client application 114 or third-party application 132, can then utilize the Bloom filter with the optimal parameters and the optimal value of the number of bits set to one in the bit array determined above, in real time, during execution of a user interface function. For example, a user interface function may display a first display type or a second display type, based on the number of distinct values in a dataset corresponding to the user interface function. For instance, the user interface function can be a function called to display a visual depiction of values (e.g., all values or a filtered subset of the values) in the dataset. It may make sense to display the value in a pie chart, unless there are too many values for it to be readable. Accordingly, the user interface function can specify a threshold for the user interface function (e.g., 10, 15, 20) to display the values in a first display type (e.g., pie chart) only if the number of distinct values is below the threshold. Otherwise, a second display type (e.g., bar chart, line chart, listing) is used to display the values.

For example, a user can select an option in a user interface of an application, such as an analytics application, to show values or a subset of values in a given dataset. Based on receiving a request for the user interface function, the computing system (or a computing device, such as user device 110), initializes a bit array comprising the optimized bit array size determine previously, such as 10,000 in the example described above. The computing system incrementally processes the values in the dataset corresponding to the user interface function, by performing the following functions. First, the computing system applies the optimal number of hash functions to a value in the data set to determine one or more bit positions in the bit array. The computing system next sets the bits at the determined one or more bit positions to one and counts the total number of bits set to one in the bit array. The computing system compares the total number to the optimized bit threshold value determined above. The computing system stops the incremental processing when the total number of bits set to one in the bit array reaches the optimized bit threshold value indicating a number of distinct values exceeds the threshold (e.g., 10, 15, 20) for the given user interface function. The computing system can then execute the user interface function using a first display type (e.g., bar chart, line graph, listing) instead of a second display type (e.g., pie chart) based on determining that the number of distinct values exceeds the threshold for the given user interface function. This process can be done in real-time or near real-time from the user selection of the user interface option to display values for a given data set.

Further, computing device can determine whether a value in the dataset is filtered out of the dataset for the user interface function (e.g., the user has selected a subset of types of values to be displayed) and skip entering into the bit array the value that has been filtered out.

In view of the above disclosure, various examples are set forth below. It should be noted that one or more features of an example, taken in isolation or combination, should be considered within the disclosure of this application.

Example 1. A computer-implemented method comprising:
initializing a bit array of a predetermined size and a predefined number of hash functions;
for a given dataset, preforming operations, for a specified number of iterations, to generate a set of results comprising a result for each iteration, comprising:
   inserting a first element of a plurality of elements of the given dataset into the bit array by setting at least one bit to one in the bit array;
   for each element of the plurality of elements, after the first element, that is inserted in the bit array, performing operations comprising:
      applying a hash function to the element to produce an index in the bit array;
      setting a bit to one at the index in the bit array;
      counting a number of collisions that occur; and
      updating a number of bits set to one in the bit array based on the number of collisions;
analyzing the set of results to determine a number of bits set to one in the bit array after inserting the plurality of elements, for each result; and
selecting an optimized bit array size and an optimal number of hash functions based on a mean and standard deviation of the number of bits set to one in the bit array for a given number of hash functions given a specified user interface threshold value for a given user interface function.
   Example 2. A computer-implemented method according to any of the previous examples, further comprising:
determining an optimal value of the number of bits set to one in the bit array to achieve a given confidence level that a specified user interface threshold value is met by determining a value where a mean plus three times a standard deviation of the set of results exceeds a user interface threshold value; and
setting the optimal value to the value.
   Example 3. A computer-implemented method according to any of the previous examples, further comprising:
based on receiving a request for a user interface function, initializing a second bit array comprising the optimized bit array size;
incrementally processing values in a dataset corresponding to the user interface function, by performing operations comprising:
   applying the optimal number of hash functions to a value to determine one or more bit positions in the second bit array;
   setting bits at the determined one or more bit positions to one;
   counting a total number of bits set to one in the second bit array;
   comparing the total number to the optimized bit threshold value; and
   stopping the incremental processing when the total number of bits set to one in the second bit array reaches the optimized bit threshold value indicating a number of distinct values exceeds the threshold for the given user interface function.
      Example 4. A computer-implemented method according to any of the previous examples, further comprising:
implementing the user interface function using a first display type instead of a second display type based on determining that number of distinct values exceeds the threshold for the given user interface function.
   Example 5. A computer-implemented method according to any of the previous examples, further comprising:
determining whether a value is filtered out of the dataset for the user interface function, and skipping the value based on determining that it is filtered out.
   Example 6. The computer-implemented method of claim 1 wherein the bit array is a Bloom filter.
   Example 7. A computer-implemented method according to any of the previous examples, wherein after initializing the bit array, the method comprises:
calculating a probability of a collision occurring when inserting elements into the bit array, wherein a collision happens when a hash function maps an element to a bit that is already set to one in the bit array.
   Example 8. A computer-implemented method according to any of the previous examples, wherein the probability of at least one collision when inserting an nth element is calculated by:

$$collision\_probability = 1 - {( 1 - 1 / m )}^{k \cdot n}$$

Example 9. A computer-implemented method according to any of the previous examples, wherein the predefined number of hash functions are used to map each value to an array position in the bit array.
Example 10. A system comprising:
a memory that stores instructions; and
   one or more processors configured by the instructions to perform operations comprising:
initializing a bit array of a predetermined size and a predefined number of hash functions;
for a given dataset, preforming operations, for a specified number of iterations, to generate a set of results comprising a result for each iteration, comprising:
   inserting a first element of a plurality of elements of the given dataset into the bit array by setting at least one bit to one in the bit array;
   for each element of the plurality of elements, after the first element, that is inserted in the bit array, performing operations comprising:
      applying a hash function to the element to produce an index in the bit array;
      setting a bit to one at the index in the bit array;
      counting a number of collisions that occur; and
      updating a number of bits set to one in the bit array based on the number of collisions;
analyzing the set of results to determine a number of bits set to one in the bit array after inserting the plurality of elements, for each result; and
selecting an optimized bit array size and an optimal number of hash functions based on a mean and standard deviation of the number of bits set to one in the bit array for a given number of hash functions given a specified user interface threshold value for a given user interface function.
   Example 11. A system according to any of the previous examples, the operations further comprising:
determining an optimal value of the number of bits set to one in the bit array to achieve a given confidence level that a specified user interface threshold value is met by determining a value where a mean plus three times a standard deviation of the set of results exceeds a user interface threshold value; and
setting the optimal value to the value.
   Example 12. A system according to any of the previous examples, the operations further comprising:
based on receiving a request for a user interface function, initializing a second bit array comprising the optimized bit array size;
incrementally processing values in a dataset corresponding to the user interface function, by performing operations comprising:
   applying the optimal number of hash functions to a value to determine one or more bit positions in the second bit array;
   setting bits at the determined one or more bit positions to one;
   counting a total number of bits set to one in the second bit array;
   comparing the total number to the optimized bit threshold value; and
   stopping the incremental processing when the total number of bits set to one in the second bit array reaches the optimized bit threshold value indicating a number of distinct values exceeds the threshold for the given user interface function.
      Example 13. A system according to any of the previous examples, the operations further comprising:
implementing the user interface function using a first display type instead of a second display type based on determining that number of distinct values exceeds the threshold for the given user interface function.
   Example 14. A system according to any of the previous examples, further comprising:
determining whether a value is filtered out of the dataset for the user interface function, and skipping the value based on determining that it is filtered out.
   Example 15. A system according to any of the previous examples wherein the bit array is a Bloom filter.
   Example 16. A system according to any of the previous examples, wherein after initializing the bit array, the operations comprising:
calculating a probability of a collision occurring when inserting elements into the bit array, wherein a collision happens when a hash function maps an element to a bit that is already set to one in the bit array.
   Example 17. A system according to any of the previous examples, wherein the probability of at least one collision when inserting an nth element is calculated by: collision_probability=1−(1−1/m)^{k·n}.
   Example 18. A system according to any of the previous examples, wherein the predefined number of hash functions are used to map each value to an array position in the bit array.
   Example 19. A non-transitory computer-readable medium comprising instructions stored thereon that are executable by at least one processor to cause a computing device to perform operations comprising:
initializing a bit array of a predetermined size and a predefined number of hash functions;
for a given dataset, preforming operations, for a specified number of iterations, to generate a set of results comprising a result for each iteration, comprising:
   inserting a first element of a plurality of elements of the given dataset into the bit array by setting at least one bit to one in the bit array;
   for each element of the plurality of elements, after the first element, that is inserted in the bit array, performing operations comprising:
      applying a hash function to the element to produce an index in the bit array;
      setting a bit to one at the index in the bit array;
      counting a number of collisions that occur; and
      updating a number of bits set to one in the bit array based on the number of collisions;
analyzing the set of results to determine a number of bits set to one in the bit array after inserting the plurality of elements, for each result; and
selecting an optimized bit array size and an optimal number of hash functions based on a mean and standard deviation of the number of bits set to one in the bit array for a given number of hash functions given a specified user interface threshold value for a given user interface function.
   Example 20. A non-transitory computer-readable medium according to any of the previous examples, the operations further comprising:
determining an optimal value of the number of bits set to one in the bit array to achieve a given confidence level that a specified user interface threshold value is met by determining a value where a mean plus three times a standard deviation of the set of results exceeds a user interface threshold value; and
setting the optimal value to the value.

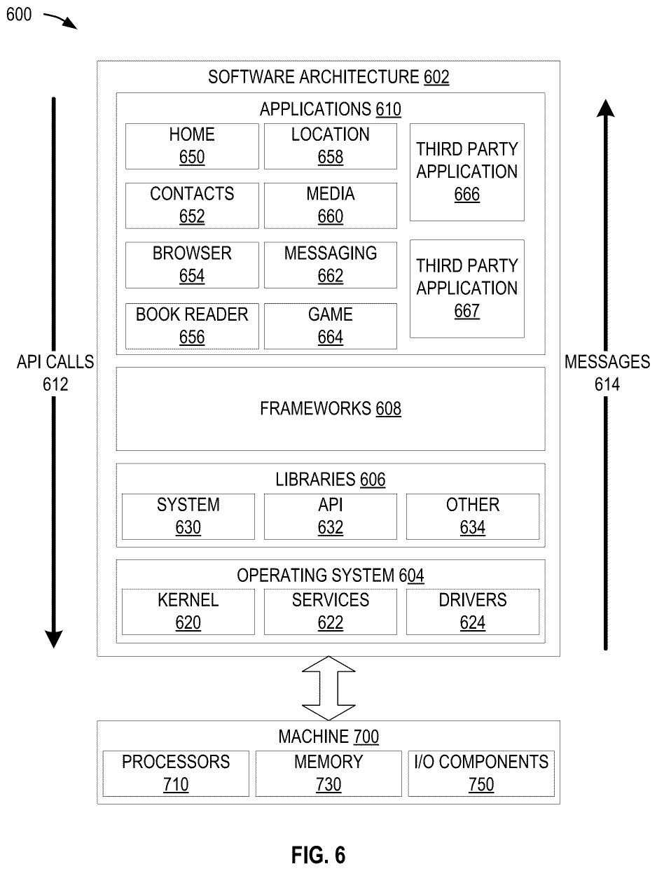

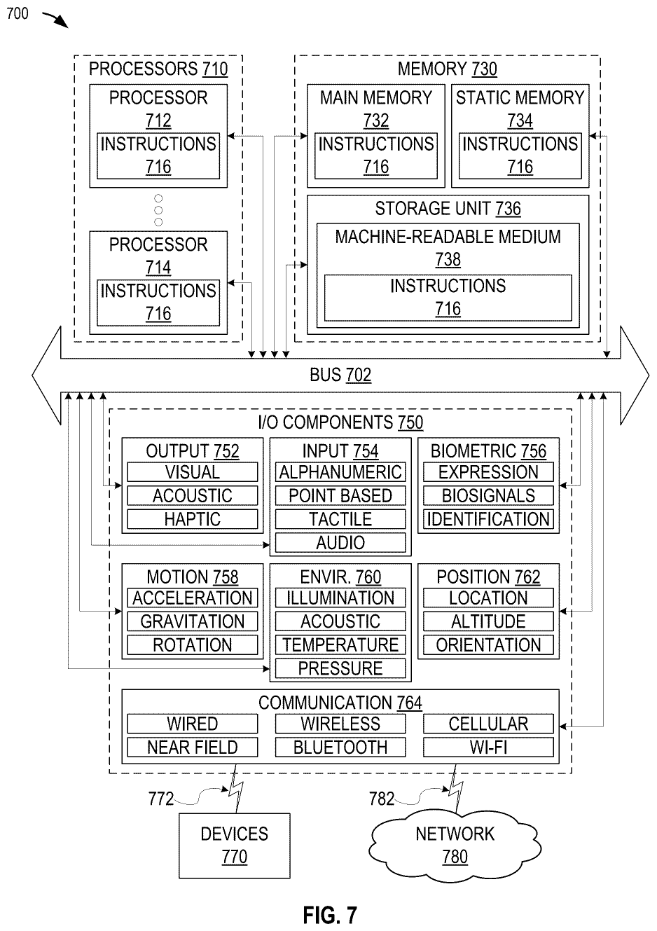

FIG. 6 is a block diagram 600 illustrating software architecture 602, which can be installed on any one or more of the devices described above. For example, in various embodiments, user devices 110 and servers and systems 130, 62, 120, 122, and 124 may be implemented using some or all of the elements of software architecture 602. FIG. 6 is merely a non-limiting example of a software architecture, and it will be appreciated that many other architectures can be implemented to facilitate the functionality described herein. In various embodiments, the software architecture 602 is implemented by hardware such as machine 700 of FIG. 7 that includes processors 710, memory 730, and input/output (I/O) components 750. In this example, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke application programming interface (API) calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphical user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications such as third-party applications 666 and 667. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 is a block diagram illustrating components of a machine 700, according to some embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein can be executed. In alternative embodiments, the machine 700 operates as a standalone device or can be coupled (e.g., networked) to other machines. In a networked deployment, the machine 700 may operate in the capacity of a server machine or system 130, 102, 120, 122, 124, etc., or a user device 110 in a server-client network environment, or as a peer machine in a peer-to-peer (or distributed) network environment. The machine 700 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

In various embodiments, the machine 700 comprises processors 710, memory 730, and I/O components 750, which can be configured to communicate with each other via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 712 and a processor 714 that may execute the instructions 716. The term “processor” is intended to include multi-core processors 710 that may comprise two or more independent processors 712, 714 (also referred to as “cores”) that can execute instructions 716 contemporaneously. Although FIG. 7 shows multiple processors 710, the machine 700 may include a single processor 710 with a single core, a single processor 710 with multiple cores (e.g., a multi-core processor 710), multiple processors 712, 714 with a single core, multiple processors 712, 714 with multiples cores, or any combination thereof.

The memory 730 comprises a main memory 732, a static memory 734, and a storage unit 736 accessible to the processors 710 via the bus 702, according to some embodiments. The storage unit 736 can include a machine-readable medium 738 on which are stored the instructions 716 embodying any one or more of the methodologies or functions described herein. The instructions 716 can also reside, completely or at least partially, within the main memory 732, within the static memory 734, within at least one of the processors 710 (e.g., within the processor's cache memory), or any suitable combination thereof, during execution thereof by the machine 700. Accordingly, in various embodiments, the main memory 732, the static memory 734, and the processors 710 are considered machine-readable media 738.

As used herein, the term “memory” refers to a machine-readable medium 738 able to store data temporarily or permanently and may be taken to include, but not be limited to, random-access memory (RAM), read-only memory (ROM), buffer memory, flash memory, and cache memory. While the machine-readable medium 738 is shown, in an example embodiment, to be a single medium, the term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 750 include a wide variety of components to receive input, provide output, produce output, transmit information, exchange information, capture measurements, and so on. In general, it will be appreciated that the I/O components 750 can include many other components that are not shown in FIG. 7. The I/O components 750 are grouped according to functionality merely for simplifying the following discussion, and the grouping is in no way limiting. In various example embodiments, the I/O components 750 include output components 752 and input components 754. The output components 752 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 750 include biometric components 756, motion components 758, environmental components 760, or position components 762, among a wide array of other components. For example, the biometric components 756 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 include acceleration sensor components (e.g., accelerometer), gravitation sensor components, rotation sensor components (e.g., gyroscope), and so forth. The environmental components 760 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 762 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 750 may include communication components 764 operable to couple the machine 700 to a network 780 or devices 770 via a coupling 782 and a coupling 772, respectively. For example, the communication components 764 include a network interface component or another suitable device to interface with the network 780. In further examples, communication components 764 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 770 may be another machine 700 or any of a wide variety of peripheral devices (e.g., a peripheral device coupled via a Universal Serial Bus (USB)).

Moreover, in some embodiments, the communication components 764 detect identifiers or include components operable to detect identifiers. For example, the communication components 764 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 764, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 780 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 716 are transmitted or received over the network 780 using a transmission medium via a network interface device (e.g., a network interface component included in the communication components 764) and utilizing any one of a number of well-known transfer protocols (e.g., Hypertext Transfer Protocol (HTTP)). Similarly, in other example embodiments, the instructions 716 are transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Furthermore, the machine-readable medium 738 is non-transitory (in other words, not having any transitory signals) in that it does not embody a propagating signal. However, labeling the machine-readable medium 738 “non-transitory” should not be construed to mean that the medium is incapable of movement; the machine-readable medium 738 should be considered as being transportable from one physical location to another. Additionally, since the machine-readable medium 738 is tangible, the machine-readable medium 738 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
initializing a bit array of a predetermined size and a predefined number of hash functions;
for a given dataset, preforming operations, for a specified number of iterations, to generate a set of results comprising a result for each iteration, comprising:
inserting a first element of a plurality of elements of the given dataset into the bit array by setting at least one bit to one in the bit array;
for each element of the plurality of elements, after the first element, that is inserted in the bit array, performing operations comprising:
applying a hash function to the element to produce an index in the bit array;
setting a bit to one at the index in the bit array;
counting a number of collisions that occur; and
updating a number of bits set to one in the bit array based on the number of collisions;
analyzing the set of results to determine a number of bits set to one in the bit array after inserting the plurality of elements, for each result;
selecting an optimized bit array size and an optimal number of hash functions based on a mean and standard deviation of the number of bits set to one in the bit array for a given number of hash functions given a specified user interface threshold value for a given user interface function; and
storing the optimized bit array size and an optimal number of hash functions in one or more datastores.

2. The computer-implemented method of claim 1, further comprising:
determining an optimal value of the number of bits set to one in the bit array to achieve a given confidence level that a specified user interface threshold value is met by determining a value where a mean plus three times a standard deviation of the set of results exceeds a user interface threshold value; and
setting the optimal value to the value.

3. The computer-implemented method of claim 2, further comprising:
based on receiving a request for a user interface function, initializing a second bit array comprising the optimized bit array size;
incrementally processing values in a dataset corresponding to the user interface function, by performing operations comprising:
applying the optimal number of hash functions to a value to determine one or more bit positions in the second bit array;
setting bits at the determined one or more bit positions to one;
counting a total number of bits set to one in the second bit array;
comparing the total number to the optimized bit threshold value; and
stopping the incremental processing when the total number of bits set to one in the second bit array reaches the optimized bit threshold value indicating a number of distinct values exceeds the threshold for the given user interface function.

4. The computer-implemented method of claim 3, further comprising:
implementing the user interface function using a first display type instead of a second display type based on determining that number of distinct values exceeds the threshold for the given user interface function.

5. The computer-implemented method of claim 3, further comprising:
determining whether a value is filtered out of the dataset for the user interface function, and skipping the value based on determining that it is filtered out.

6. The computer-implemented method of claim 1 wherein the bit array is a Bloom filter.

7. The computer-implemented method of claim 1, wherein after initializing the bit array, the method comprises:
calculating a probability of a collision occurring when inserting elements into the bit array, wherein a collision happens when a hash function maps an element to a bit that is already set to one in the bit array.

8. The computer-implemented method of claim 7, wherein the probability of at least one collision when inserting an nth element is calculated by:
collision_probability=1−(1−1/m)^{k·n}.

9. The computer-implemented method of claim 1, wherein the predefined number of hash functions are used to map each value to an array position in the bit array.

10. A system comprising:
a memory that stores instructions; and
one or more processors configured by the instructions to perform operations comprising:
initializing a bit array of a predetermined size and a predefined number of hash functions;
for a given dataset, preforming operations, for a specified number of iterations, to generate a set of results comprising a result for each iteration, comprising:
inserting a first element of a plurality of elements of the given dataset into the bit array by setting at least one bit to one in the bit array;
for each element of the plurality of elements, after the first element, that is inserted in the bit array, performing operations comprising:
applying a hash function to the element to produce an index in the bit array;
setting a bit to one at the index in the bit array;
counting a number of collisions that occur; and
updating a number of bits set to one in the bit array based on the number of collisions;
analyzing the set of results to determine a number of bits set to one in the bit array after inserting the plurality of elements, for each result;
selecting an optimized bit array size and an optimal number of hash functions based on a mean and standard deviation of the number of bits set to one in the bit array for a given number of hash functions given a specified user interface threshold value for a given user interface function; and
storing the optimized bit array size and an optimal number of hash functions in one or more datastores.

11. The system of claim 10, the operations further comprising:
determining an optimal value of the number of bits set to one in the bit array to achieve a given confidence level that a specified user interface threshold value is met by determining a value where a mean plus three times a standard deviation of the set of results exceeds a user interface threshold value; and
setting the optimal value to the value.

12. The system of claim 11, the operations further comprising:
based on receiving a request for a user interface function, initializing a second bit array comprising the optimized bit array size;
incrementally processing values in a dataset corresponding to the user interface function, by performing operations comprising:
applying the optimal number of hash functions to a value to determine one or more bit positions in the second bit array;
setting bits at the determined one or more bit positions to one;
counting a total number of bits set to one in the second bit array;
comparing the total number to the optimized bit threshold value; and
stopping the incremental processing when the total number of bits set to one in the second bit array reaches the optimized bit threshold value indicating a number of distinct values exceeds the threshold for the given user interface function.

13. The system of claim 12, the operations further comprising:
implementing the user interface function using a first display type instead of a second display type based on determining that number of distinct values exceeds the threshold for the given user interface function.

14. The system of claim 12, further comprising:
determining whether a value is filtered out of the dataset for the user interface function, and skipping the value based on determining that it is filtered out.

15. The system of claim 10 wherein the bit array is a Bloom filter.

16. The system of claim 10, wherein after initializing the bit array, the operations comprising:
calculating a probability of a collision occurring when inserting elements into the bit array, wherein a collision happens when a hash function maps an element to a bit that is already set to one in the bit array.

17. The system of claim 16, wherein the probability of at least one collision when inserting an nth element is calculated by:
collision_probability=1−(1−1/m)^{k·n}.

18. The system of claim 10, wherein the predefined number of hash functions are used to map each value to an array position in the bit array.

19. A non-transitory computer-readable medium comprising instructions stored thereon that are executable by at least one processor to cause a computing device to perform operations comprising:
initializing a bit array of a predetermined size and a predefined number of hash functions;
for a given dataset, preforming operations, for a specified number of iterations, to generate a set of results comprising a result for each iteration, comprising:
inserting a first element of a plurality of elements of the given dataset into the bit array by setting at least one bit to one in the bit array;
for each element of the plurality of elements, after the first element, that is inserted in the bit array, performing operations comprising:
applying a hash function to the element to produce an index in the bit array;
setting a bit to one at the index in the bit array;
counting a number of collisions that occur; and
updating a number of bits set to one in the bit array based on the number of collisions;
analyzing the set of results to determine a number of bits set to one in the bit array after inserting the plurality of elements, for each result;
selecting an optimized bit array size and an optimal number of hash functions based on a mean and standard deviation of the number of bits set to one in the bit array for a given number of hash functions given a specified user interface threshold value for a given user interface function; and
storing the optimized bit array size and an optimal number of hash functions in one or more datastores.

20. The non-transitory computer-readable medium of claim 19, the operations further comprising:
determining an optimal value of the number of bits set to one in the bit array to achieve a given confidence level that a specified user interface threshold value is met by determining a value where a mean plus three times a standard deviation of the set of results exceeds a user interface threshold value; and
setting the optimal value to the value.
